(19) United States
(12) Patent Application Publication
(10) Pub. No.: US 2013/0290650 A1
(43) Pub. Date: Oct. 31, 2013

(54) DISTRIBUTED ACTIVE DATA STORAGE SYSTEM

(71) Applicants: Jichuan Chang, Sunnyvale, CA (US); Parthasarathy Ranganathan, San Jose, CA (US); Nathan Lorenzo Binkert, Redwood City, CA (US)

(72) Inventors: Jichuan Chang, Sunnyvale, CA (US); Parthasarathy Ranganathan, San Jose, CA (US); Nathan Lorenzo Binkert, Redwood City, CA (US)

(21) Appl. No.: 13/459,970

(22) Filed: Apr. 30, 2012

(51) Int. Cl. G06F 12/00

(52) U.S. Cl. 711/154; 711/E12.001

(57) ABSTRACT

A request from a requestor identifies data stored in a distributed active data storage system and a procedure that is associated with the identified data for a given node of the distributed active data storage system to execute. The execution of the procedure causes the given node to selectively determine an address for routing another request to an element of a plurality of elements of a data structure stored on the plurality of nodes.

### BACKGROUND

A data storage system, such as a storage network, has typically been used to respond to requests from a host. In this regard, a typical data storage system responds to read and write requests for purposes of reading from and writing data to the data storage system. Another type of data storage system is an active data storage system in which the storage system performs some degree of processing beyond mere reads and writes.

### BRIEF DESCRIPTION OF THE DRAWINGS

FIG. 1 is a schematic diagram of a computer system containing a distributed data storage system according to an example implementation.

FIG. 2 is a flow diagram depicting a technique to request a node of the distributed data storage system of FIG. 1 to execute a procedure according to an example implementation.

FIG. 3 is an illustration of a request communicated to a node of the distributed data storage system of FIG. 1 according to an example implementation.

FIG. 4 is a flow diagram depicting the use of intra-node routing to fulfill a request communicated to the distributed data storage system of FIG. 1 according to an example implementation.

FIG. 5 is a flow diagram depicting the use of fully distributed routing to fulfill a request communicated to the distributed data storage system of FIG. 1 according to an example implementation.

FIG. 6 is a schematic diagram of a node of the distributed data storage system of FIG. 1 according to an example implementation.

FIG. 7 is a schematic diagram of the requestor of FIG. 1 according to an example implementation.

### DETAILED DESCRIPTION

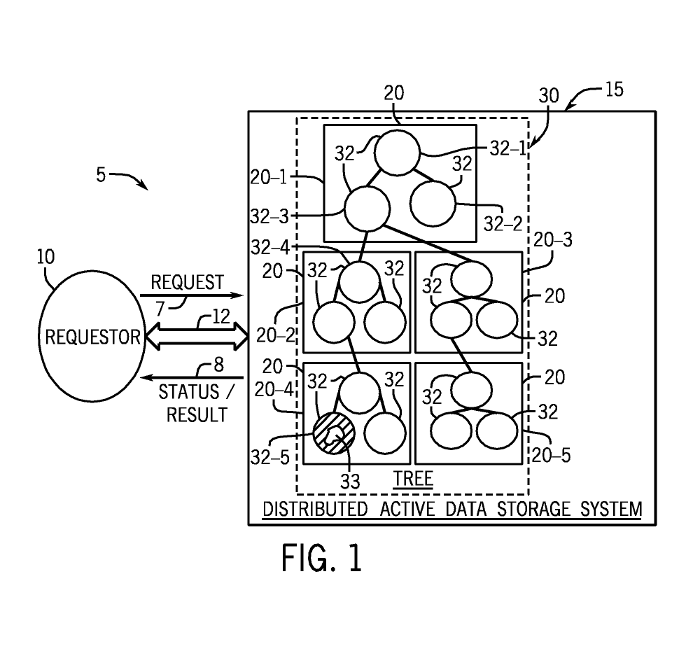

Referring to FIG. 1, an example computer system 5 includes a distributed active data storage system 15, which stores data that may be accessed by one or multiple requesters 10 (clients and/or host, as non-limiting examples) for purposes of reading data, updating data, writing additional data, erasing data, and so forth. Being an active storage system, the distributed active data storage system 15 performs some degree of processing in addition to merely responding to read and write requests from a requestor 10. In this regard, in addition to reading data, updating data, writing additional data, erasing data, and so forth, the distributed active data storage system 15 may further process the data and thus, may execute some degree of applications. FIG. 1 depicts a particular example in which an example requestor 10 communicates a request 7 to the distributed active data storage system 15 over a communication link 12 (a local area network (LAN) communication link, a wide area network (WAN) communication link, and so forth); and in response to the request 7, the distributed active data storage system 15 communicates one or multiple statuses and/or results, as denoted by reference numeral 8 to the requestor 10 via the communication link 12.

For example, the requestor 10 may provide a key identifying a particular element 32 of the distributed active data storage system 15 that stores data, which the requestor 10 requests to be retrieved, or read, from the system 15; and in response to the request, the distributed active data storage system 15 retrieves the data and provides the data to the requestor 10 as a result 8.

In general, the distributed active data storage system 15 contains nodes 20 (example nodes 20-1, 20-2, 20-3, 20-4 and 20-5, being depicted in FIG. 1), which are coupled together but are independent such that each node 20 individually stores and access its stored data. In this manner, each node 20, in accordance with example implementations, is a processor-based entity that accesses locally-stored data on the node 20 and, in response to an appropriate request, modifies, reads or writes data to its local memory.

As non-limiting examples, the distributed active data storage system 15 may be an active memory storage system, such as a hybrid memory cube system; a system of input/output (I/O) nodes that are coupled together via an expansion bus, such as a Peripheral Component Interconnect (PCIe) bus; or, in general, a system of networked I/O nodes 20. For these implementations, each node 20, in general, contains and controls local access to a memory and further contains one or multiple processors, such one or multiple central processing units (CPUs), for example.

Alternatively, in accordance with some implementations, the distributed active data storage system 15 may be a mass storage system in which the nodes 20 of the system contain one or multiple mass storage devices, such as tape drives, magnetic storage devices, optical drives, and so forth. For these implementations, the nodes may be coupled together by, as non-limiting examples, a serial attach Small Computer System Interface (SCSI) bus, a parallel attach SCSI bus, a Universal Serial Bus (USB) bus, a Fibre Channel bus, an Ethernet bus, and so forth. For these implementations, each node contains one or more mass storage devices and further contains a local controller (a processor-based controller, for example) that controls access to the local mass storage device(s).

Thus, the distributed active data storage system 15 may be a distributed active memory storage system or a distributed active mass storage system, depending on the particular implementation. Regardless of the particular implementation, each node 20 contains local memory, and access to the local memory is controlled by the node 20. The nodes 20 may be interconnected in one of many different interconnection topologies, such as a tree topology, a mesh topology, a mesh topology, a torus topology, a bus topology, a ring topology, and so forth.

Regardless of whether the distributed active data storage system 15 is an active memory system or an active storage system, in accordance with example implementations, the distributed active data storage system 15 may organize its data storage in a given hierarchical structure that the system 15 to locate data identified by the request 7. For the non-limiting example depicted in FIG. 1, the hierarchical structure is a tree 30, such as a binary tree. In this manner, as illustrated in FIG. 1, the tree 30 may be organized such that each node 20 stores data for a different part of the tree 30.

More specifically, the tree 30 contains hierarchically-arranged internal software nodes, or “data storage elements 32”; and each node 20 contains one or multiple elements 32, depending on the particular implementation. For the specific example of a binary search tree 30, which is depicted in FIG. 1, each node 20 contains three elements 32: a parent element 32 and two child elements 32. The child elements 32, in turn, may be organized in a particular hierarchy, such that the tree 30 may, in general, be traversed in a structured manner for purposes of locating data that is stored in a particular element 32.

For the example of FIG. 1, each node 20 contains one parent element and two child elements. The node 20-1 contains a root element 32-1 (also a parent element 32) of the tree 30 and two corresponding child elements 32-2 and 32-3. A parent element 32-4 of the node is connected to the child element 32-3 of the node 20-1, and so forth.

During its course of operation, the requestor 10 may submit one or multiple requests 7 over a communication link 12 to the distributed active data storage system 15 for purposes of accessing data stored on the distributed active data storage system 15. For example, the requestor 10 may access the distributed active data storage system 15 for purposes of inserting an element 32 into the tree 30, deleting an element 32 from the tree 30, reading data from a given element 32, writing data to a given element 32, and so forth. The interaction between the requestor 10 and the distributed active data storage system 15, in turn, may be performed in different ways and may be associated with differing levels of interaction by the requestor 10, depending on the implementation.

For example, one way for the requestor 10 to access data of the distributed active data storage system 15 is for the requestor 10 to interact directly and individually with the nodes 20 until the desired data is located/accessed. As a more specific example, for a binary tree traversal operation in which the requestor 10 desires to search the binary tree 30 to find certain data (a desired file, for example), the requestor 10 may begin the search by communicating with the root node 20-1 for the tree 30 and more specifically, by reading the appropriate elements 32 of the node 20-1.

As an example of this approach, data 33 that is the target of the search may reside in element 32-5 (a leaf), which is stored for this example in node 20-4. The requestor 10 begins the search with the root node 20-1 of the tree 30 by communicating with the node 20-1 to read the root element 32-1. Thus, in response to the request, the node 20-1 provides data from the root element 32-1 to the requestor 10. In response to processing the data provided by the node 20-1, the requestor 10 recognizes that the element 32-1 does not store the data 33 and proceeds to communicate with the node 20-1 to read the data of node 32-3, taking into account the hierarchical ordering of the tree 30. This process proceeds by the requestor 10 issuing read requests to the node 20-1, 20-2 and 20-4 to read data from elements 32 of the nodes 20-1, 20-2 and 20-4, until the requestor 10 locates the data 33 in the element 32-12 of node 20-4. For this example, the requestor 10 is thus involved in every read operation with the elements 32, thereby potentially consuming a significant amount of bandwidth of the communication link 12 between the requestor 10 and the distributed active data storage system 15.

In accordance with systems and techniques, which are disclosed herein, the nodes 20 execute procedures (as contrasted to the requestor 10 executing the procedures) to guide the tree traversal process, i.e., the nodes 20 determine to some extent when to terminate the traversal process, where to continue traversal process, and so forth. The degree in which the requestor 10 participates in computations to access the desired data stored/to be stored in the tree 30 may vary, depending on the particular implementation.

For example, in accordance with example implementations, the requestor 10 may participate in inter-node routing, and the nodes 20 of the distributed active data storage system 15 may perform intra-node routing. More specifically, for these implementations, the requestor 10 may communicate with a given node 20 to initiate a procedure by the node 20 in which the node transverses one or multiple elements 32 of the node 20 to execute the procedure. For example, the requestor 10 may communicate with a request 7 to a given node 20, which requests the node 20 to find data corresponding to a key; and in response to the request, the node 20 reads data from its parent element 32; decides whether the data has been located; and proceeds traversing its elements 32 until all of the elements 32 of the node 20 have been traversed or the data has been found. At this point, the node 20 either returns a status to the requestor 10 indicating that more searching is to be performed by another node 20, or the node 20 returns the requested data. If the requested data was not found by the node 20, the requestor 20 then identifies the next node 20 of the tree 30, considering the tree's hierarchy, and proceeds with communicating the request to that node 20.

As a more specific example, the requestor 10 may use intra-node routing to traverse the tree 30 to locate targeted data in the tree 30. The requestor 10 first communicates a request 7 to the parent node 20-1 identifying the targeted data; and in response to the request 7, the parent node 20-1 reads the element 32-1 and subsequently reads the element 32-3. Upon recognizing that the element 32-3 does not contain the targeted data, the node 20-1 returns a result 8 to the requestor 10 indicating that the data was not found. The requestor 10 then makes the determination that the node 20-2 is the next node 20 in the traversal process and proceeds to communicate a corresponding request 7 to the node 20-2. The traversal of the tree 30 occurs in this manner until the node 20-4 reads the targeted data from the element 32-5 and provides this data to the requestor 10.

In accordance with further implementations, distributed active data storage system 15 uses fully distributed routing in which the nodes 20 selectively requests to other nodes 20, which may involve less interaction between the nodes 20 and the requestor 10. More specifically, for the traversal example that is set forth above, the requestor 10 communicates a single request 7 to the parent node 20-1 to begin the traversal of the tree 30.

Upon reading data from the element 32-1, the node 20-1 then reads data from the element 32-3. Upon recognizing, based on the read data from the leaf 32-3 that the node 20-2 is to be accessed, the node 20-1 generates a request to the node 20-2 for the node 20-2 to continue the traversal process. In this manner, the node 20-2 uses intra-node accesses to continue the traversal of its internal elements 32, and the node 20-1 generates an external request to the node 20-4 to cause the node 20-4 to continue the traversal. Ultimately, the node 20-4 discovers the data in the element 32-5 and provides the result 8 to the requestor 10.

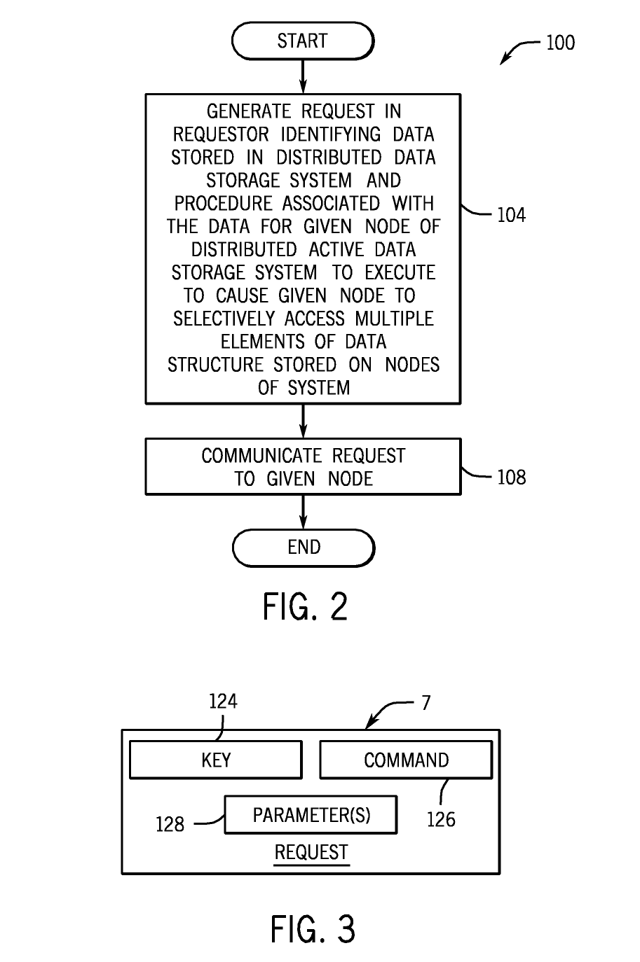

Thus, referring to FIG. 2, in accordance with example implementations that are disclosed herein, a technique 100 for use with the computer system 5 includes generating (block 104) a request in a requestor, which identifies data stored in a distributed data storage system and a procedure that is associated with the data for a given node of the distributed data storage system to execute. This request is communicated to the given node, pursuant to block 108. Depending on the particular implementation, the processing of the request either involves fully distributed routing by the distributed active data storage system 15 or a processing that involves intra-node routing, as discussed above. Regardless of whether the processing of the request involves fully distributed routing or intra-node routing, the processing includes selectively accessing a plurality of elements of a data structure that is stored on the nodes, and this access includes the node determining an address (external or internal) for the next element that the node accesses.

Referring to FIG. 3, in accordance with example implementations, an example request 7, which may be communicated either by the requestor 10 to the distributed active data storage system 15 or between nodes 20 of the distributed active data storage system 15, includes a key 124 that identifies requested data. Moreover, the request 7 may contain one or more commands 126, which are executed by the node 20 that receives the request for purposes of performing a procedure associated with the targeted data. For the example that is set forth above, the command 126 is a traversal command, although other commands may be communicated via the requests 7, in accordance with further implementations. The request 7 may further include one or multiple parameters 128, which are associated with the command 126.

In accordance with some implementations, to communicate a request 7 to the distributed active data storage system 15, the requestor 10 uses a stub of the requestor 10 to issue the request, and a corresponding stub of the receiving node 20 converts the parameter(s) to the corresponding parameter(s) used by the node 20. In accordance with some implementations, the request 7 may be similar to a remote procedure call (RPC), although other formats may be employed, in accordance with further implementations.

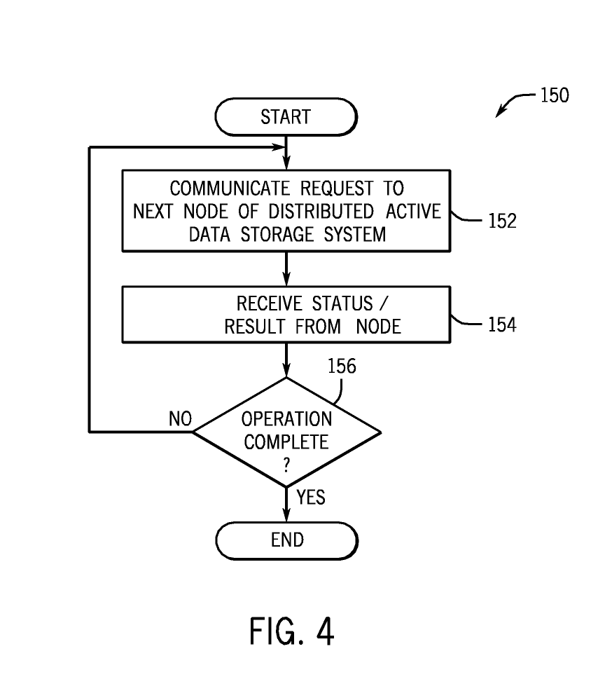

Referring to FIG. 4 in conjunction with FIG. 1, in accordance with example implementations, for intra-node routing, the requestor 10 may use a technique 150, which includes communicating a request to the next node of a distributed data storage system, pursuant to block 152. In response to the request, the requestor 10 receives (block 154) either a status or result from the node to which the request was communicated. If the node communicates a result that indicates that the operation is complete (as determined in decision block 156), then the technique 150 terminates. Otherwise, the operation is not complete, and the requestor 10 processes the returned result to target another node and communicate (block 152) a request to this node to perform another iteration.

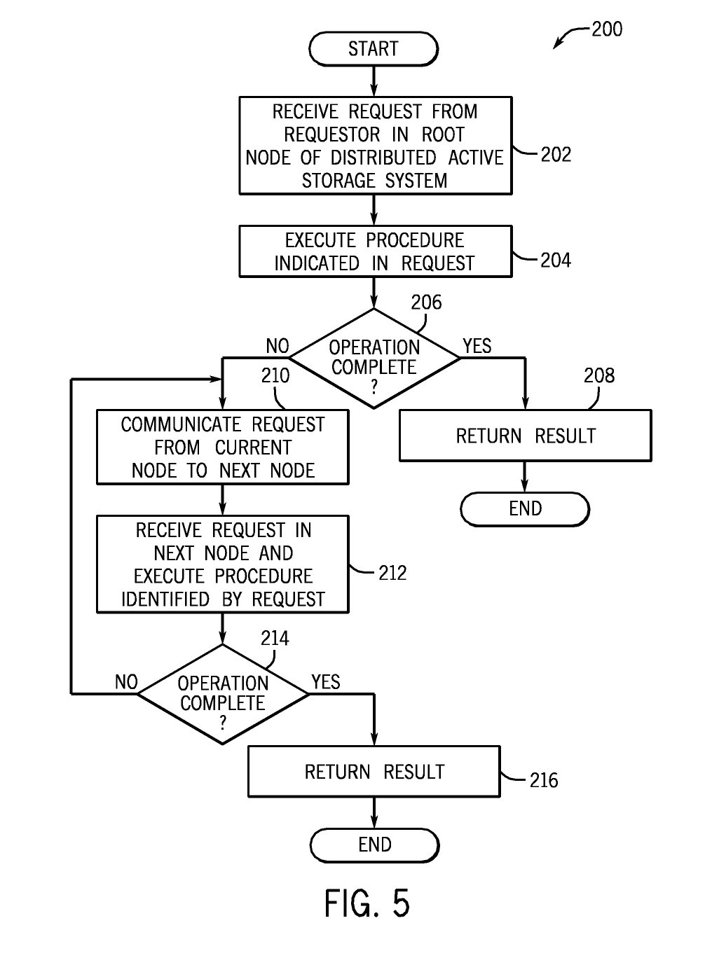

Referring to FIG. 5 in conjunction with FIG. 1, in accordance with example implementations, a technique 200 may be employed by the distributed active data storage system 15, when fully distributed routing is employed. Pursuant to the technique 200, a root node of the distributed data storage system receives a request from a requestor, pursuant to block 202. The procedure that is identified by the request is then executed by the root node, pursuant to block 204. As a non-limiting example, this procedure may be a procedure to traverse the portion of a tree associated with the root node for purposes of locating data identified by the request, for example. Regardless of the particular operation, if the root node completes the operation (as determined in decision block 206), then the corresponding result is returned (block 208) to the requestor. Otherwise, the requestor is involved in iterations with one or multiple other nodes of the distributed data storage system.

In this manner, if a determination is made pursuant to decision block 206 that the operation is not complete, the current node communicates a request to the next node, pursuant to block 210. This request is received in the next, and the next node executes the procedure that is identified by the request, pursuant to block 212. If a determination is made (diamond 214) that the operation is complete, then the result is returned to the requestor, pursuant to block 216. Otherwise, another iteration occurs, and control returns to block 210.

Among the particular advantages with the intra-node and fully distributed node routing disclosed herein, reduced round trips between the nodes and the requestor may reduce network traffic, reduce total execution time (i.e., reduce latency) and may, in general, translate into significantly lower loads on the requestor, thereby enhancing performance and efficiency. Moreover, the routing disclosed herein may reduce a number of network messages, which correspondingly reduces the network bandwidth.

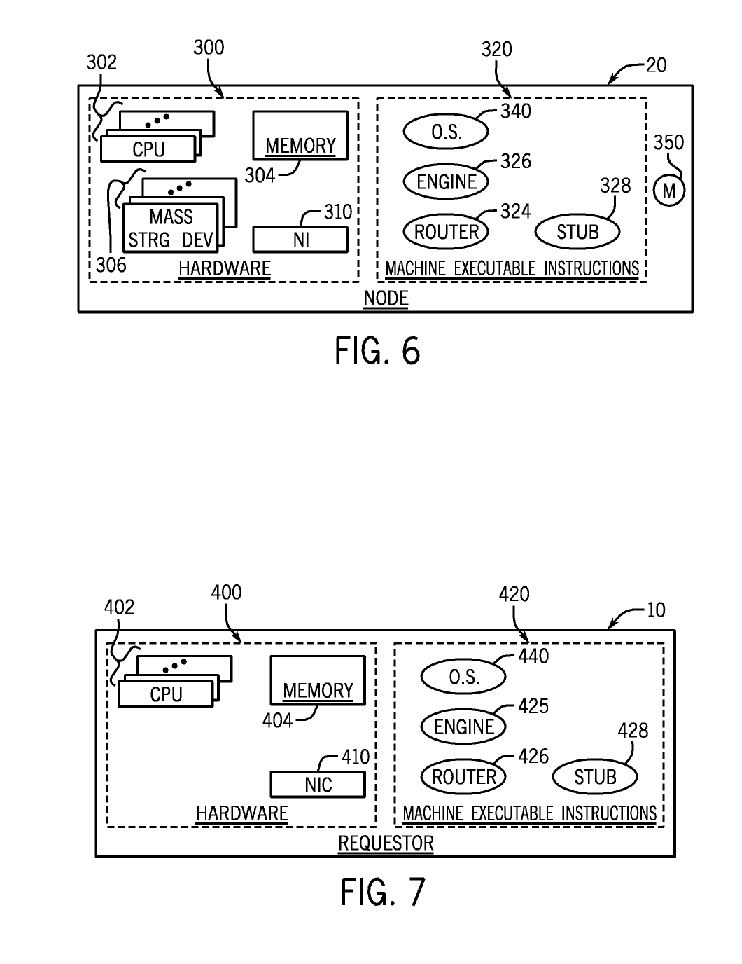

Referring to FIG. 6, in general, the node 20 is a “physical machine,” or an actual machine that is made up of machine executable instructions 320 (i.e., “software”) and hardware 300. In accordance with some implementations, the physical machine may be located within one cabinet (or rack); or alternatively, the physical machine may be located in multiple cabinets (or racks).

The node 20 may include such hardware 300 as one or multiple central processing units (CPUs) 302 and a memory 304, which stores the machine executable instructions 320, parameter data for the node 20, data for a mapping directory 350, configuration data, and so forth. In general, the memory 304 is a non-transitory memory, which may include semiconductor storage devices, magnetic storage devices, optical storage devices, and so forth. The hardware 300 may further include one or multiple mass storage devices 306 and a network interface 310 for purposes of communicating with the requestor 10 and other nodes 20.

The machine executable instructions 320 of the node 20, in general, may include instructions that when executed by the CPU(s) 302, form a router 324 that communicates messages, such as the request 7, across network fabric between the node 20 and another node 20, between the node 20 and the requestor 10 or internally within the node 20. In this manner, for intra node routing, the router 324 may forward a message to the next hop of an internal software node, or element 32; and for fully distributed routing, the router 324 may forward a particular message either to the next hop of a remote node or to an internal node, or element 32, of the node 20. The machine executable instructions 320 may further include machine executable instructions that, when executed by the CPUs 302, form an execution engine 326. In this regard, the execution engine 326 executes the procedure that is contained in requests from the requestor 10 and other nodes 20.

Moreover, the engine 326, in accordance with example implementations, may generate internal requests for the elements 32 of the node 20, generate requests for external nodes, determine when external nodes are to be accessed, and so forth. In accordance with some implementations, the engine 326 may communicate a notification back to the requestor 7 when the engine 326 hands off a computation to another node 20. This communication, in turn, permits the requestor 10 to monitor the progress of the computation and take corrective action, when appropriate.

The engine 326 may further employ the use of the mapping directory 350. In this manner, for purposes of the node 20 determining if data is stored locally and the address of the and if not stored locally, where the data is stored, the mapping directory 350 may be used by the engine 326 to arithmetically calculate an address where the data is located. In accordance with some implementations, the mapping directory 350 may be a local directory with data to local mappings, or addresses. In accordance with further implementations, the mapping directory 350 may be part of a global, distributed directory, which contains global addresses that may be consulted by the engine 326 for the mapping information. In yet further implementations, the engine 326 may consult a centralized global mapping directory for purposes of determining addresses where particular data is located. It is noted that for the distributed, global directory, if data mappings are permitted to change during computation, then coherence mechanisms may be employed for purposes of updating the distributed directories to maintain coherency.

The node 20 may contain various other machine executable instructions 320, in accordance with further implementations. In this manner, the node 20 may contain machine executable instructions 320 that, when executed, form a stub 328 used by the node 20 for purposes of parameter conversion, an operating system 340, device drivers, applications, and so forth.

Referring to FIG. 7, in accordance with example implementations, the requestor 10 is a “physical machine,” or an actual machine that is made up of machine executable instructions 420 and hardware 400. Although the requestor 10 is represented as being contained within a box, the requestor 10 may be a distributed machine, which has multiple nodes that provide a distributed and parallel processing system. In accordance with some implementations, the physical machine may be located within one cabinet (or rack); or alternatively, the physical machine may be located in multiple cabinets (or racks).

The requestor 10 may contain such hardware 400 as one or more CPUs flow to and a memory 404 that stores the machine executable instructions 420, application data, configuration data, and so forth. In general, the memory 404 is a non-transitory memory, which may include semiconductor storage devices, magnetic storage devices, optical storage devices, and so forth. The requestor 10 also includes a network interface 410 for purposes of communicating with the communication link 12 (see FIG. 1) with the distributed active data storage system 15. It is noted that the requestor 10 may include various other hardware components, such as one or more of the following: mass storage devices, display devices, input devices (a mouse and a keyboard, for example), and so forth.

The machine executable instructions 420 of the requestor 10, in general, may include, for example, a router 426 that communicates messages to and from the distributed active data storage system 15 and an engine 425, which generate requests 7 for the distributed active data storage system 15, analyzes status responses and results obtained from the distributed active data storage system 15, determines which node 20 to communicate messages with, determines the processing order for the nodes 20 to process a given operation, and so forth. The machine executable instructions 420 may further includes instructions that when executed by the CPUs 402 cause the CPU(s) 402 to form a stub 428 for purposes of parameter conversion, an operating system 440, device drivers, applications, and so forth.

While a limited number of examples have been disclosed herein, those skilled in the art, having the benefit of this disclosure, will appreciate numerous modifications and variations therefrom. It is intended that the appended claims cover all such modifications and variations.

What is claimed is:

1. A method comprising:
generating a request in a requester identifying data stored in a distributed active data storage system and a procedure associated with the identified data for a given node of the distributed active data storage system to execute, wherein the given node is one out of a plurality of nodes of the distributed active data storage system and the request causing the given node to selectively determine an address for routing another request to an element of a plurality of elements of a data structure stored on the plurality of nodes; and
communicating the request to the given node.

2. The method of claim 1, wherein the procedure, when executed by the given node, causes the given node to return a status or results, wherein the another request identifies another procedure to be executed by another node of the plurality of nodes in response to the status or results.

3. The method of claim 1, wherein the procedure, when executed by the given node, causes the given node to selectively communicate the another request to at least one additional node of the plurality of nodes.

4. The method of claim 1, wherein generating the request comprises generating a request identifying data that may be stored by the given node and the procedure, when executed by the given node, causes the given node to perform an operation on the given node to determine whether the identified data is stored on the given node.

5. The method of claim 4, wherein the operation comprises a search operation including traversing part of at least one data structure associated with the given node.

6. The method of claim 1, wherein the distributed active data storage system comprises a distributed active mass storage system or a distributed active memory storage subsystem.

7. The method of claim 1, wherein the request causes the node to consult an address mapping to determine the address.

8. An apparatus comprising:
at least one node of a plurality of nodes of a distributed active data storage system, the at least one node comprising:
a router to communicate a request with a requestor, the request identifying data stored in the distributed active data storage system and a procedure associated with the identified data for the at least one node to execute; and
an engine to execute the procedure to cause the engine to selectively determine an address for routing another request to an element of a plurality of elements of a data structure stored on the plurality of nodes.

9. The apparatus of claim 8, wherein the engine is adapted to communicate a reply identifying a status or result associated with the execution of the procedure.

10. The apparatus of claim 8, wherein the another request identifies another procedure to be executed by another node of the plurality of nodes.

11. The apparatus of claim 8, wherein request identifies data that may be stored by the given node and the engine is adapted to, in response to executing the procedure, perform an operation on the given node to determine whether the data is stored on the given node.

12. The apparatus of claim 8, wherein the engine is adapted to search the data structure in response to executing the procedure.

13. The apparatus of claim 12, wherein the engine is adapted to selectively request another node of the plurality of nodes to perform an operation in response to execution of the procedure.

14. The apparatus of claim 8, wherein the engine is adapted to use a mapping directory to determine the address.

15. The apparatus of claim 8, wherein the plurality of nodes comprise active memory nodes.

16. The apparatus of claim 8, wherein the plurality of nodes comprise active mass storage devices.

17. An article comprising a computer readable storage medium to store instructions that when executed by a system cause the system to:
generate a request in a requester identifying data stored in a distributed active data storage system and a procedure associated with the identified data for a given node of the distributed active data storage system to execute, wherein the given node being one out of a plurality of nodes of the distributed active data storage system and the request causing the given node to selectively determine an address for routing another request to an element of a plurality of elements of a data structure stored on the plurality of nodes; and
communicate the request to the given node.

18. The article of claim 17, wherein the another request identifies another procedure to be executed by another node of the plurality of nodes.

19. The article of claim 17, wherein the procedure, when executed by the given node, causes the given node to selectively communicate at least one other additional request to at least one additional node of the plurality of nodes.

20. The article of claim 17, the storage medium storing instructions that when executed by the processor-based system cause the processor-based system to generate a request identifying data that may be stored by the given node and the procedure, when executed by the given node, causes the given node to perform a search on the given node to determine whether the data is stored on the given node.
